(19) United States
(12) Patent Application Publication
(10) Pub. No.: US 2026/0298322 A1
(43) Pub. Date: Oct. 1, 2026

(54) DIFFERENTIAL DEVICE

(71) Applicant: JTEKT CORPORATION, Kariya-shi (JP)

(72) Inventors: Yuta KIKUYA, Kariya-shi (JP); Hiroshi TAKUNO, Nukata-gun (JP); Toshimi HARA, Takahama-shi (JP); Motoyasu YAMAMORI, Nagoya-shi (JP); Takahiro YOSHIMURA, Toyota-shi (JP)

(73) Assignee: JTEKT CORPORATION, Kariya-shi (JP)

(21) Appl. No.: 19/474,912

(22) PCT Filed: May 11, 2023
(86) PCT No.: PCT/JP2023/017767

§ 371 Date: Oct. 13, 2025

(51) Int. Cl. F16H 48/14; F16H 48/22; F16H 48/42

(52) U.S. Cl. CPC F16H 48/14; F16H 48/22; F16H 48/42; F16H 2048/423

(57) ABSTRACT

A differential device includes an input rotating member that rotates around a rotation axis, a pair of output rotating members that are accommodated in the input rotating member and rotate around the rotation axis, plural differential gears that enable differential rotation of the pair of output rotating members, an engagement member that has dog teeth capable of engaging with the output rotating member and that engages with the output rotating member to prevent the output rotating member from rotating relative to the input rotating member, and a friction clutch that suppresses differential rotation between the output rotating member and the input rotating member by means of a frictional force. The engagement member is disposed inside the friction clutch in a radial direction perpendicular to the rotation axis.

### TECHNICAL FIELD

The present disclosure relates to differential devices used to distribute driving force to right and left wheels of a vehicle.

### BACKGROUND ART

In a vehicle, the driving force from a drive source such as an engine is distributed to the right and left wheels by a differential device. The differential device includes a differential gear mechanism including right and left side gears, namely a pair of output rotating members, and a plurality of pinion gears meshed with the right and left side gears. The differential gear mechanism allows differential rotation between the right and left wheels during turning.

The differential devices described in Patent Literatures 1, 2 include, in addition to the differential gear mechanism, a friction clutch that suppresses differential rotation between the right and left wheels by frictional force, a dog clutch that prohibits differential rotation between the right and left wheels by engagement of teeth, and a cam mechanism for operating the friction clutch and the dog clutch. Suppressing or prohibiting differential rotation between the right and left wheels allows the driving force to be transmitted to the other wheel even when, for example, one of the right and left wheels slips, thereby improving drivability. In the differential devices described in Patent Literatures 1, 2, the friction clutch, the dog clutch, and the cam mechanism are arranged side by side in an axial direction parallel to the vehicle width direction.

### CITATION LIST

### Patent Literature

Patent Literature 1: US 2021/0348675 A

Patent Literature 2: WO 2019/111294 A

### BRIEF SUMMARY

### Technical Problem

The differential devices described in Patent Literatures 1, 2 are provided with a friction clutch and a dog clutch, which increases the device size in the vehicle width direction. An increase in device size contributes to a reduction in mountability in a vehicle.

Accordingly, an object of the present disclosure is to provide a differential device including a friction clutch that suppresses differential rotation between a pair of output rotating members by frictional force, and an engagement member that makes the pair of output rotating members non-rotatable relative to each other by engagement of teeth, while enabling reduction in device size.

### Solution to Problem

In order to achieve the above object, the present disclosure provides a differential device including: an input rotating member in the form of a case, the input rotating member being configured to receive driving force from a drive source and to rotate about a rotational axis by the driving force; a pair of output rotating members housed in the input rotating member and configured to rotate about the rotational axis; a plurality of differential gears housed in the input rotating member and configured to allow differential rotation between the pair of output rotating members; an engagement member including dog teeth that are engageable with one of the pair of output rotating members, the engagement member being configured to axially move relative to the input rotating member to engage the dog teeth with the one output rotating member so as to make the one output rotating member non-rotatable relative to the input rotating member; and a friction clutch disposed between the one output rotating member and the input rotating member and configured to suppress differential rotation between the one output rotating member and the input rotating member by a frictional force. The engagement member and the friction clutch are arranged side by side in a radial direction perpendicular to the rotation axis and overlap each other in an axial direction, and the engagement member is disposed inward of the friction clutch in the radial direction.

### Advantageous Effects

With the differential device of the present disclosure, it is possible to reduce the device size.

### BRIEF DESCRIPTION OF DRAWINGS

FIG. 1 is a sectional view showing an example of the configuration of a differential device according to the embodiment of the present disclosure,

FIG. 2 is a partial enlarged view of a portion of FIG. 1.

FIG. 3 is a configuration diagram showing an opposing surface of a rotary cam member that faces a first driven cam member and a second driven cam member.

FIG. 4 is a perspective sectional view of the rotary cam member, showing a section taken along line A-A in FIG. 3.

FIG. 5 is a configuration diagram showing an opposing surface of the first driven cam member that faces the rotary cam member.

FIG. 6 is a configuration diagram showing an opposing surface of the second driven cam member that faces the rotary cam member.

FIG. 7A is an explanatory diagram schematically illustrating a state in which both a first thrust generation mechanism and a second thrust generation mechanism are inactive.

FIG. 7B is an explanatory diagram schematically illustrating an active state of the second thrust generation mechanism.

FIG. 7C is an explanatory diagram schematically illustrating an active state of the first thrust generation mechanism.

FIG. 7D is an explanatory diagram schematically illustrating the active state of the first thrust generation mechanism.

### DESCRIPTION OF EMBODIMENTS

### Embodiment

An embodiment of the present disclosure will be described with reference to the drawings. The embodiment described below is shown as a suitable specific example for carrying out the present disclosure, and part of the embodiment specifically illustrates various technically preferable technical matters. However, the technical scope of the present disclosure is not limited to such specific aspects.

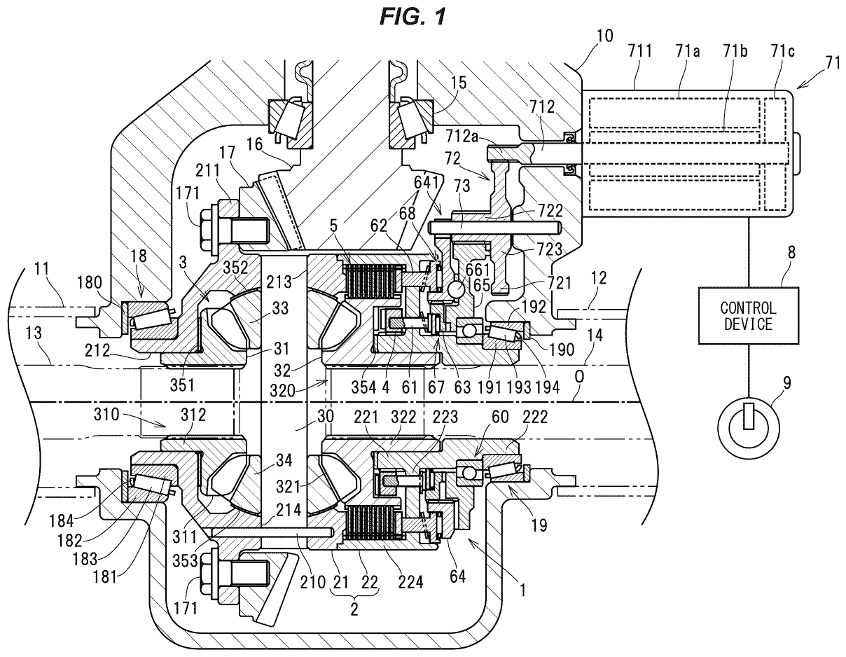

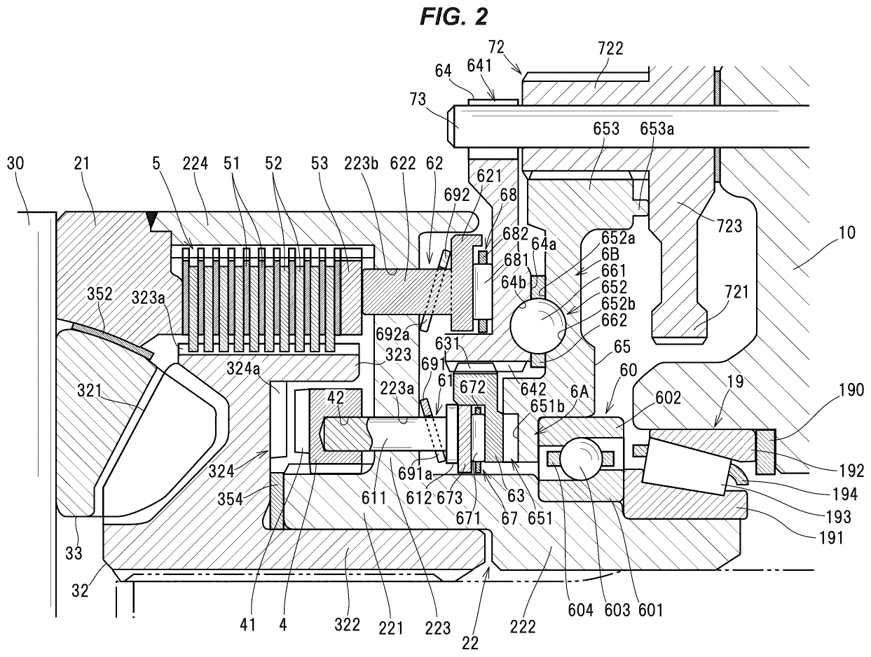

FIG. 1 is a sectional view showing an example of the configuration of a differential device 1 according to the embodiment of the present disclosure. FIG. 2 is a partial enlarged view of a portion of FIG. 1. In the following description, for convenience, the left side and the right side in FIGS. 1 and 2 are referred to as “left” and “right.” respectively. However, the terms “left” and “right” do not necessarily indicate the left and right with respect to the forward direction of the vehicle.

The differential device 1 is mounted in a vehicle and is used to distribute the driving force from a drive source such as an engine or an electric motor to the right and left wheels. FIG. 1 shows, together with the differential device 1, a differential carrier 10, left and right tubes 11, 12 attached to the differential carrier 10, left and right axle shafts 13, 14 respectively housed in the tubes 11, 12, a pinion gear shaft 16 rotatably supported with respect to the differential carrier 10 via a bearing 15, a ring gear 17 meshed with the pinion gear shaft 16, and bearings 18, 19 that support the differential device 1 with respect to the differential carrier 10. The differential device 1 distributes the driving force from the drive source, which is input via the pinion gear shaft 16, to the left and right axle shafts 13, 14 while allowing differential motion. Lubricating oil, not shown, is sealed inside the differential carrier 10.

The differential device 1 includes: an input rotating member 2 in the form of a case that rotates about a rotation axis O by the driving force from the drive source; a pinion shaft 30 fixed to the input rotating member 2; a pair of output rotating members 31, 32 to which the left and right axle shafts 13, 14 are respectively non-rotatably connected; and a plurality of differential gears 33, 34 that allows differential rotation between the output rotating members 31, 32. The output rotating members 31, 32 and the differential gears 33, 34 constitute a differential gear mechanism 3.

The output rotating members 31, 32 and the differential gears 33, 34 are housed within the input rotating member 2. The output rotating members 31, 32 rotate about the rotation axis O. The differential gears 33, 34 are supported on the pinion shaft 30. In the present embodiment, the differential gears 33, 34 are bevel gears. The output rotating members 31, 32 are meshed with the differential gears 33, 34. The left axle shaft 13 is spline-fitted into a fitting hole 310 formed in the left output rotating member 31 of the pair of output rotating members 31, 32. The right axle shaft 14 is spline-fitted into a fitting hole 320 formed in the right output rotating member 32.

Hereinafter, the direction parallel to the rotation axis O is referred to as the axial direction, and the direction perpendicular to the rotation axis O is referred to as the radial direction. The pinion shaft 30 is disposed between the output rotating members 31, 32 and extends in the radial direction.

The input rotating member 2 includes a hollow case member 21 that is open on one side in the axial direction, and a cover member 22 that closes the opening of the case member 21. The case member 21 is formed, for example, by casting. The cover member 22 is formed, for example, by forging. The cover member 22 is fixed to the case member 21 and rotates with the case member 21. The case member 21 has a flange 211 to which the ring gear 17 is fixed. The ring gear 17 is fixed to the flange 211 by a plurality of bolts 171. The driving force from the drive source is input to the input rotating member 2 via the ring gear 17. The ring gear 17 may alternatively be fixed to the case member 21 by welding.

An insertion hole 212 through which the left axle shaft 13 is inserted, and holding holes 213, 214 that respectively hold both ends of the pinion shaft 30 are formed in the case member 21. Movement of the pinion shaft 30 relative to the case member 21 is restricted by a pin 210 that is press-fitted into the case member 21 along the axial direction.

A washer 351 is disposed between the left output rotating member 31 and the case member 21. Washers 352, 353 are also respectively disposed between the differential gears 33, 34 and the case member 21. The left output rotating member 31 integrally includes gear teeth 311 that mesh with the differential gears 33, 34, and a cylindrical boss portion 312 that is fitted into the insertion hole 212 of the case member 21.

The cover member 22 integrally includes a large-diameter cylindrical portion 221, a small-diameter cylindrical portion 222, a wall 223 in the form of an annular plate, and an outer cylindrical portion 224 that extends in the axial direction from an outer peripheral end of the wall 223. The outer diameter and inner diameter of the large-diameter cylindrical portion 221 are larger than the outer diameter and inner diameter of the small-diameter cylindrical portion 222. The right axle shaft 14 is inserted through the interiors of the large-diameter cylindrical portion 221 and the small-diameter cylindrical portion 222. The wall 223 is formed so as to protrude radially outward from the large-diameter cylindrical portion 221. One axial end of the outer cylindrical portion 224 is welded to the case member 21. A washer 354 is disposed between the right output rotating member 32 and one axial end of the large-diameter cylindrical portion 221.

In the input rotating member 2, the case member 21 is rotatably supported with respect to the differential carrier 10 via the bearing 18, and the small-diameter cylindrical portion 222 of the cover member 22 is rotatably supported with respect to the differential carrier 10 via the bearing 19. The bearings 18, 19 are tapered roller bearings, and each include an inner ring 181, 191 and an outer ring 182, 192, a plurality of rolling elements 183, 193 in the shape of partial cones disposed between the inner ring 181, 191 and the outer ring 182, 192, and a cage 184, 194 that holds the plurality of rolling elements 183, 193. Shims 180, 190 for adjusting the clearance are respectively disposed between the outer rings 182, 192 and the differential carrier 10.

The differential device 1 further includes an engagement member 4 that makes the right output rotating member 32 non-rotatable relative to the input rotating member 2, and a friction clutch 5 that suppresses differential rotation between the right output rotating member 32 and the input rotating member 2 by frictional force. The right output rotating member 32 and the left output rotating member 31 are connected via the differential gears 3 34. Therefore, when the right output rotating member 32 becomes non-rotatable relative to the input rotating member 2 by the engagement member 4, the left output rotating member 31 also becomes non-rotatable relative to the input rotating member 2. Since differential rotation between the right output rotating member 32 and the input rotating member 2 is suppressed by the friction clutch 5, differential rotation between the left output rotating member 31 and the input rotating member 2 is also suppressed. Since differential rotation between the output rotating members 31, 32 and the input rotating member 2 is restricted or suppressed, spinning of the left wheel and the right wheel is reduced, thereby improving drivability of the vehicle and enabling the vehicle to stably travel on, for example, rough roads or low-μ roads.

The engagement member 4 is disposed on the outer periphery of the large-diameter cylindrical portion 221 of the cover member 22, and is spline-fitted to the large-diameter cylindrical portion 221 so as to be axially movable and non-rotatable relative to the large-diameter cylindrical portion 221. The engagement member 4 is disposed between the output rotating member 32 and the wall 223 of the cover member 22, As shown in FIG. 2, the engagement member 4 has a plurality of dog teeth 41 that is engageable with the output rotating member 32. When the engagement member 4 is moved axially relative to the input rotating member 2, the plurality of dog teeth 41 engages with the output rotating member 32, thereby making the output rotating member 32 non-rotatable relative to the input rotating member 2.

The friction clutch 5 is disposed between the output rotating member 32 and the outer cylindrical portion 224 of the cover member 22. The friction clutch 5 includes: a plurality of outer clutch plates 51 that is axially movable and non-rotatable relative to the input rotating member 2; a plurality of inner clutch plates 52 that is axially movable and non-rotatable relative to the output rotating member 32; and a pressure plate 53 disposed so as to face the cover member 22. The plurality of outer clutch plates 51 and the plurality of inner clutch plates 52 are alternately arranged along the axial direction. The pressure plate 53 is disposed adjacent to the plurality of outer clutch plates 51 and the plurality of inner clutch plates 52 in the axial direction, and is axially movable and non-rotatable relative to the input rotating member 2.

The output rotating member 32 integrally includes: gear teeth 321 that mesh with the differential gears 33, 34; a cylindrical boss portion 322 that is fitted into the large-diameter cylindrical portion 221 of the cover member 22; an outer peripheral spline fitting portion 323 having external splines 323a with which the plurality of inner clutch plates 52 engages; and an engagement portion 324 having a plurality of engagement teeth 324a that engages with the plurality of dog teeth 41 of the engagement member 4.

The engagement member 4 is disposed inward of the friction clutch S in the radial direction perpendicular to the rotation axis O. The engagement portion 324 of the output rotating member 32 is provided inward of the outer peripheral spline fitting portion 323 in the radial direction.

The differential device 1 further includes: a first pressing member 61 that presses the engagement member 4 in the axial direction; a second pressing member 62 that presses the friction clutch 5 in the axial direction; a first driven cam member 63 disposed adjacent to the first pressing member 61 in the axial direction; a second driven cam member 64 disposed adjacent to the second pressing member 62 in the axial direction; a rotary cam member 65 disposed so as to face the first driven cam member 63 and the second driven cam member 64 in the axial direction; a plurality of cam balls 661 and a cage 662 that are disposed between the second driven cam member 64 and the rotary cam member 65; a first thrust bearing 67 disposed between the first pressing member 61 and the first driven cam member 63; a second thrust bearing 68 disposed between the second pressing member 62 and the second driven cam member 64; a first biasing member 691 that elastically biases the first pressing member 61 toward the first thrust bearing 67; a second biasing member 692 that elastically biases the second pressing member 62 toward the second thrust bearing 68; and a bearing 60 disposed between the rotary cam member 65 and the cover member 22. The cam balls 661 are in the shape of balls. The cage 662 holds the plurality of cam balls 661 at equal intervals in the circumferential direction.

In the present embodiment, the first pressing member 61 integrally includes a cylindrical shaft 611 and a head 612 having a larger diameter than the shaft 611. The differential device 1 includes a plurality of the first pressing members 61. The plurality of first pressing members 61 is disposed adjacent to the first thrust bearing 67 in the axial direction, and is arranged around the large-diameter cylindrical portion 221 of the cover member 22.

In the wall 223 of the cover member 22, a plurality of first through holes 223a is formed through which the shafts 611 of the plurality of first pressing members 61 are respectively inserted. Each first through hole 223a is formed to extend through the input rotating member 2 in the axial direction from inside to outside, The plurality of first pressing members 61 is axially movable relative to the input rotating member 2. The heads 612 of the first pressing members 61 are disposed outside the input rotating member 2 together with the first biasing member 691.

In the engagement member 4, fitting holes 42 are formed into which one ends of the shafts 611 of the plurality of first pressing members 61 are respectively press-fitted. The plurality of first pressing members 61 is fixed to the engagement member 4 by press-fitting the shafts 611 into the fitting holes 42. However, the method for fixing the engagement member 4 and the first pressing members 61 is not limited to this. For example, the first pressing members 61 may be fixed to the engagement member 4 by retaining members such as snap rings.

The engagement member 4 moves in the axial direction together with the plurality of first pressing members 61. When the engagement member 4 moves toward the output rotating member 32, the dog teeth 41 of the engagement member 4 engage with the engagement portion 324 of the output rotating member 32, thereby making the engagement member 4 and the output rotating member 32 non-rotatable relative to each other.

The first biasing member 691 is a disc spring having a plurality of notches 691a. The shaft 611 of each of the first pressing members 61 is inserted through a corresponding one of the notches 691a of the first biasing member 691. The first biasing member 691 contacts the heads 612 of the plurality of first pressing members 61 and biases the heads 612 of the plurality of first pressing members 61 so as to move them away from the wall 223 of the cover member 22 in the axial direction.

The first thrust bearing 67 includes a plurality of needle rollers 671, a cage 672 that holds the plurality of needle rollers 671, and a thrust race 673 in the form of an annular plate on which the needle rollers 671 roll. The heads 612 of the plurality of first pressing members 61 are in contact with the thrust race 673.

The second pressing member 62 integrally includes a base 621 in the form of a flat plate and a plurality of cylindrical protrusions 622 extending in the axial direction. Each protrusion 622 is integrally connected at its proximal end in the axial direction to the base 621. The base 621 is formed in an annular shape, is disposed adjacent to the second thrust bearing 68 in the axial direction, and is arranged around the plurality of first pressing members 61. In the wall 223 of the cover member 22, a plurality of second through holes 223b is formed through which the plurality of protrusions 622 of the second pressing member 62 is respectively inserted. Each second through hole 223b is formed to extend through the input rotating member 2 in the axial direction from inside to outside. The base 621 is disposed outside the input rotating member 2 together with the second biasing member 692.

The plurality of protrusions 622 of the second pressing member 62 faces the pressure plate 53 of the friction clutch 5 in the axial direction. The second pressing member 62 is axially movable relative to the input rotating member 2. When the second pressing member 62 moves toward the friction clutch 5, the plurality of outer clutch plates 51 and the plurality of inner clutch plates 52 come into frictional contact with each other, generating frictional force that suppresses differential rotation between the output rotating member 32 and the input rotating member 2. The frictional sliding between the outer clutch plate 51 and the inner clutch plate 52 is lubricated by lubricating oil.

The second biasing member 692 is a disc spring having a plurality of notches 692a Each protrusion 622 of the second pressing member 62 is inserted through a corresponding one of the notches 692a of the second biasing member 692. The second biasing member 692 contacts the base 621 of the second pressing member 62 and biases the base 621 so as to move it away from the wall 223 of the cover member 22 in the axial direction.

The second thrust bearing 68 includes a plurality of needle rollers 681 and a cage 682 that holds the plurality of needle rollers 681. The plurality of needle rollers 681 rolls on the base 621 of the second pressing member 62.

The first driven cam member 63 is disposed radially inward of the second driven cam member 64. The first driven cam member 63 and the second driven cam member 64 are engaged with each other so as to be axially movable relative to each other and non-rotatable relative to each other. More specifically, the second driven cam member 64 is spline-fitted into the first driven cam member 63. The first driven cam member 63 and the second driven cam member 64 move in the axial direction relative to the differential carrier 10 as the rotary cam member 65 rotates relative to the differential carrier 10.

The differential device 1 includes, as a configuration for rotating the rotary cam member 65 relative to the differential carrier 10, an electric motor 71 fixed to the differential carrier 10, a reduction gear 72 including a large-diameter gear portion 721 and a small-diameter gear portion 722, a support member 73 that rotatably supports the reduction gear 72 relative to the differential carrier 10, and a control device 8 that controls the electric motor 71. The reduction gear 72 includes a disc-shaped plate portion 723 on the inner side of the large-diameter gear portion 721. In the reduction gear 72, the pitch circle diameter of the large-diameter gear portion 721 is larger than the pitch circle diameter of the small-diameter gear portion 722.

The control device 8 is capable of recognizing the operation state of a mode select switch 9 operated by the vehicle driver. The mode select switch 9 allows selection among: a normal mode in which the engagement member 4 is not engaged with the engagement portion 324 of the output rotating member 32 and the friction clutch 5 is not pressed; an auto mode in which a frictional force suitable for the traveling state of the vehicle is generated in the friction clutch 5; and a lock mode in which the engagement member 4 is engaged with the engagement portion 324 of the output rotating member 32, thereby making the left and right output rotating members 31, 32 non-rotatable relative to each other.

The electric motor 71 includes a motor case 711 fixed to the differential carrier 10. and an output rotation shaft 712 having a gear portion 712a. The motor case 711 houses a stator 71a fixed to the motor case 711, a rotor 71b that rotates with the output rotation shaft 712 relative to the stator 71a, and a position detector 71c that detects the position of the rotor 71b relative to the stator 71a. The position detector 71c may be, for example, an encoder or a resolver. When current is supplied from the control device 8 to the electric motor 71, the output rotation shaft 712 rotates relative to the motor case 711. The gear portion 712a of the output rotation shaft 712 is meshed with the large-diameter gear portion 721 of the reduction gear 72.

The second driven cam member 64 includes an engaging portion 641 that engages with the support member 73, and is restrained from rotating relative to the differential carrier 10 by the support member 73. The second driven cam member 64 is also axially movable along the support member 73 with the engaging portion 641 engaging with the support member 73. The first driven cam member 63 is spline-fitted in the second driven cam member 64. Therefore, like the second driven cam member 64, the first driven cam member 63 is axially movable and non-rotatable relative to the differential carrier 10.

The bearing 60 rotatably supports the rotary cam member 65 relative to the input rotating member 2. The bearing 60 is an angular contact ball bearing, and includes an inner ring 601 and an outer ring 602, a plurality of rolling elements 603 in the shape of balls disposed between the inner ring 601 and the outer ring 602, and a cage 604 that holds the plurality of rolling elements 603. The inner ring 601 is fitted on the small-diameter cylindrical portion 222 of the cover member 22, and is disposed adjacent to the inner ring 191 of the bearing 19 in the axial direction. Axial movement of the inner ring 601 in the direction away from the large-diameter cylindrical portion 221 is restricted by the inner ring 191 of the bearing 19.

The rotary cam member 65 meshes with the small-diameter gear portion 722 of the reduction gear 72 and rotates at a lower speed than the reduction gear 72. Axial movement of the rotary cam member 65 in the direction away from the first driven cam member 63 and the second driven cam member 64 is restricted by the bearing 60.

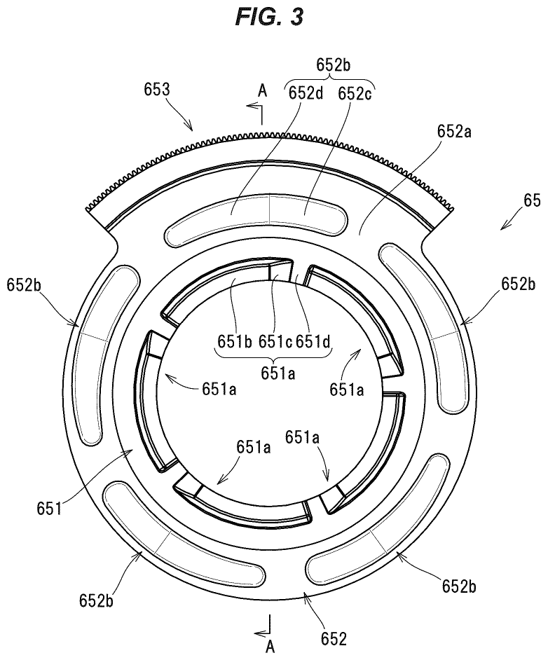

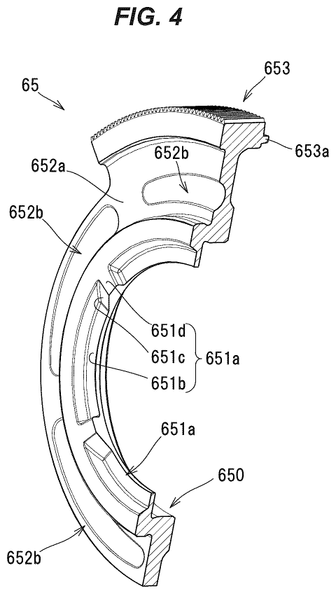

FIG. 3 is a configuration diagram showing an opposing surface of the rotary cam member 65 that faces the first driven cam member 63 and the second driven cam member 64. FIG. 4 is a perspective sectional view of the rotary cam member 65, showing a section taken along line A-A in FIG. 3.

The rotary cam member 65 integrally includes a first cam portion 651 that faces the first driven cam member 63 in the axial direction, a second cam portion 652 that faces the second driven cam member 64 in the axial direction, and a gear portion 653 that meshes with the small-diameter gear portion 722 of the reduction gear 72. A bearing fitting portion into which the outer ring 602 of the bearing 60 is fitted is formed at the inner peripheral end of the rotary cam member 65.

The first cam portion 651 is provided at the inner periphery of the second cam portion 652. The gear portion 653 is provided at the outer periphery of the second cam portion 652. The gear portion 653 has an arcuate shape as viewed in the axial direction. A projection 653a that contacts the plate portion 723 of the reduction gear 72 is provided on the surface of the gear portion 653 that faces the plate portion 723. The projection 653a defines the axial position of the gear portion 653 relative to the reduction gear 72.

A plurality of cam sliding surfaces 651a is formed on the first cam portion 651. The cam sliding surfaces 651a extend in the circumferential direction of the rotary cam member 65 and are formed in an arcuate shape. In the present embodiment, five cam sliding surfaces 651a are formed on the first cam portion 651. Each cam sliding surface 651a includes a perpendicular surface 651b and a base surface 651d, both perpendicular to the axial direction, and an inclined surface 651c formed between the perpendicular surface 651b and the base surface 651d. The inclined surface 651c is inclined with respect to the axial direction. The base surface 651d is located closer to the first driven cam member 63 than the perpendicular surface 651b in the axial direction.

In the second cam portion 652, a plurality of cam grooves 652b recessed in the axial direction from an opposing surface 652a facing the second driven cam member 64 is formed in an arcuate shape. Each cam groove 652b includes a deep groove portion 652c having a constant axial depth from the opposing surface 652a, and an inclined groove portion 652d whose axial depth from the opposing surface 652a gradually decreases from the deep groove portion 652c. The greater the distance from the deep groove portion 652c, the smaller the depth of the inclined groove portion 652d becomes.

In the present embodiment, five cam grooves 652b are formed on the second cam portion 652. The plurality of cam grooves 652b is formed outward of the plurality of cam sliding surfaces 651a in the radial direction of the rotary cam member 65.

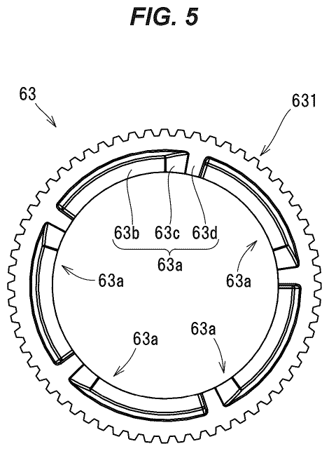

FIG. 5 is a configuration diagram showing an opposing surface of the first driven cam member 63 that faces the rotary cam member 65. Like the first cam portion 651 of the rotary cam member 65, a plurality of cam sliding surfaces 63a is formed on the first driven cam member 63. Each cam sliding surface 63a is formed in an arcuate shape so as to face a corresponding one of the cam sliding surfaces 651a of the first cam portion 651 in the axial direction, and includes a perpendicular surface 63b and a base surface 63d, both perpendicular to the axial direction, and an inclined surface 63c formed between the perpendicular surface 63b and the base surface 63d so as to be inclined with respect to the axial direction. The base surface 63d is located closer to the rotary cam member 65 than the perpendicular surface 63b in the axial direction. A spline fitting portion 631 is provided at the outer peripheral end of the first driven cam member 63.

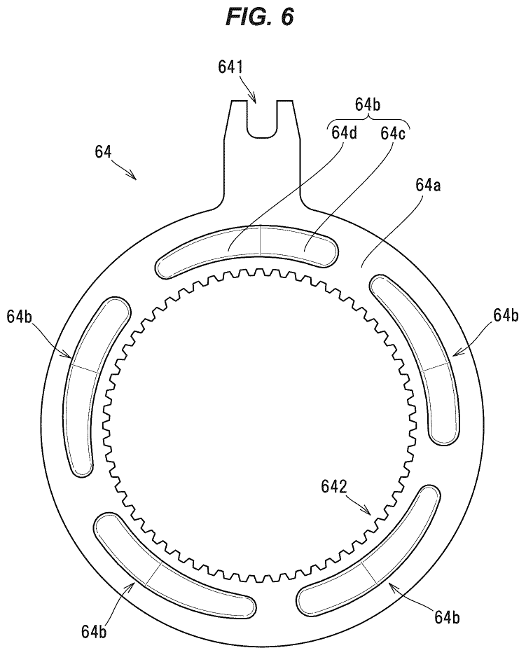

FIG. 6 is a configuration diagram showing an opposing surface of the second driven cam member 64 that faces the rotary cam member 65. In the second driven cam member 64, a plurality of cam grooves 64b recessed in the axial direction from an opposing surface 64a facing the rotary cam member 65 is formed in an arcuate shape so as to extend along the circumferential direction of the second driven cam member 64. Each cam groove 64b includes a deep groove portion 64c having a constant axial depth from the opposing surface 64a, and an inclined groove portion 64d whose axial depth from the opposing surface 64a gradually decreases from the deep groove portion 64c. The greater the distance from the deep groove portion 64c, the smaller the depth of the inclined groove portion 64d becomes. A spline fitting portion 642 into which the spline fitting portion 631 of the first driven cam member 63 is fitted is provided at the radially inner end of the second driven cam member 64.

The first driven cam member 63, the first thrust bearing 67, and the first cam portion 651 of the rotary cam member 65 constitute a first thrust generation mechanism 6A that applies axial thrust to the plurality of first pressing members 61. The second driven cam member 64, the second thrust bearing 68, and the second cam portion 652 of the rotary cam member 65 constitute a second thrust generation mechanism 6B that applies axial thrust to the second pressing member 62. The first thrust generation mechanism 6A is provided inward of the second thrust generation mechanism 6B in the radial direction of the differential device 1.

The first thrust generation mechanism 6A is a sliding cam mechanism that applies axial thrust to the plurality of first pressing members 61 through relative rotation between the first driven cam member 63 and the rotary cam member 65. The second thrust generation mechanism 6B is a ball cam mechanism that applies axial thrust to the second pressing member 62 by rolling of cam balls 661 along the inclined groove portions 652d of the cam grooves 652b of the rotary cam member 65 and the inclined groove portions 64d of the cam grooves 64b of the second driven cam member 64.

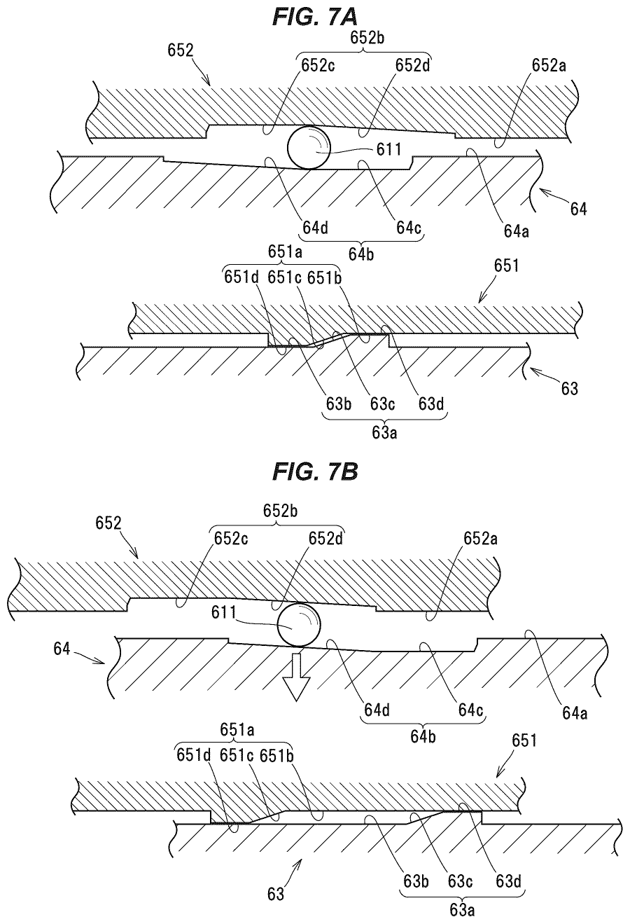

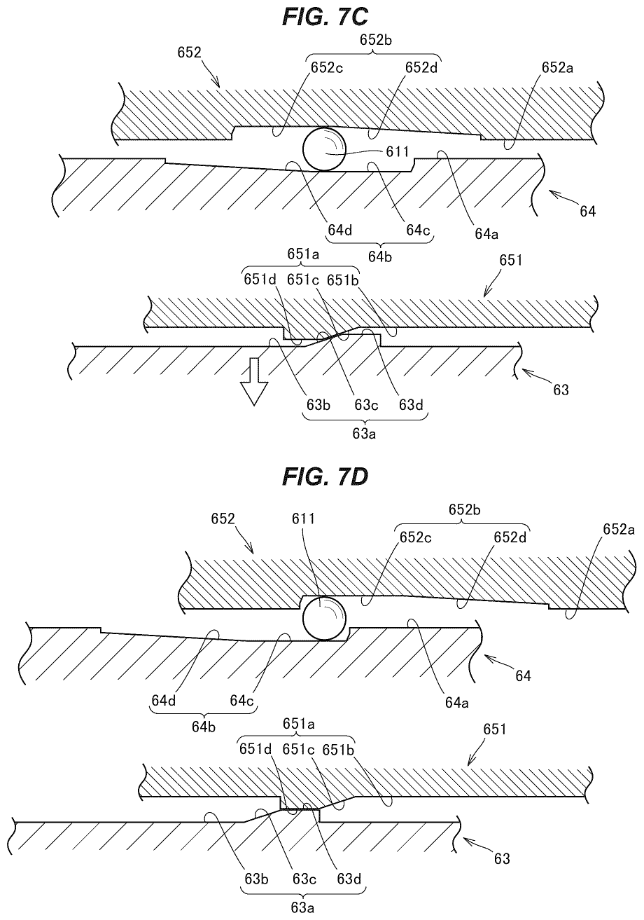

FIGS. 7A to 7D are explanatory diagrams illustrating the operations of the first thrust generation mechanism 6A and the second thrust generation mechanism 6B. FIG. 7A schematically illustrates a state in which both the first thrust generation mechanism 6A and the second thrust generation mechanism 6B are inactive. FIG. 7B schematically illustrates an active state of the second thrust generation mechanism 6B. FIGS. 7C and 7D schematically illustrate an active state of the first thrust generation mechanism 6A. In FIGS. 7A to 7D, the vertical direction in the drawings corresponds to the axial direction of the differential device 1.

In the inactive state of the first thrust generation mechanism 6A, the entire base surface 651d of the cam sliding surface 651a of the rotary cam member 65 faces the perpendicular surface 63b of the cam sliding surface 63a of the first driven cam member 63 in the axial direction, and the entire base surface 63d of the cam sliding surface 63a of the first driven cam member 63 faces the perpendicular surface 651b of the cam sliding surface 651a of the rotary cam member 65. When the first thrust generation mechanism 6A is in the inactive state, the axial position of the first driven cam member 63 is located farthest from the wall 223 of the cover member 22 due to the biasing force of the first biasing member 691, and the plurality of dog teeth 41 of the engagement member 4 does not engage with the engagement portion 324 of the output rotating member 32.

In the inactive state of the second thrust generation mechanism 6B, the cam ball 661 is located in the deep groove portion 652c of the cam groove 652b of the rotary cam member 65 and the deep groove portion 64c of the cam groove 64b of the second driven cam member 64. When the second thrust generation mechanism 6B is in the inactive state, the axial position of the second driven cam member 64 is located farthest from the wall 223 of the cover member 22 due to the biasing force of the second biasing member 692, and the friction clutch 5 is not pressed in the axial direction.

As shown in FIG. 7A, when both the first thrust generation mechanism 6A and the second thrust generation mechanism 6B are in the inactive state, relative rotation between the left and right output rotating members 31, 32 is not restricted by the engagement member 4 or the friction clutch 5, and the driving force transmitted to the left and right wheels becomes substantially equal.

FIG. 7B illustrates a state in which the rotary cam member 65 has moved to the left in the drawing from the state shown in FIG. 7A. In this state, the cam ball 661 rolls and moves into the inclined groove portion 652d of the cam groove 652b of the rotary cam member 65 and the inclined groove portion 64d of the second driven cam member 64, generating axial cam thrust indicated by the arrow in FIG. 7B in the second driven cam member 64. This cam thrust causes the second pressing member 62 to press the friction clutch 5 in the axial direction, thereby generating a frictional force between the plurality of outer clutch plates 51 and the plurality of inner clutch plates 52. Meanwhile, the entire base surface 63d of the cam sliding surface 63a of the first driven cam member 63 remains facing the perpendicular surface 651b of the cam sliding surface 651a of the rotary cam member 65 in the axial direction, and the second thrust generation mechanism 6B remains in the inactive state.

FIG. 7C illustrates a state in which the rotary cam member 65 has moved to the right in the drawing from the state shown in FIG. 7A, and the inclined surface 651c of the cam sliding surface 651a of the rotary cam member 65 is in contact with the inclined surface 63c of the cam sliding surface 63a of the first driven cam member 63. In this state, the inclined surface 651c of the cam sliding surface 651a of the rotary cam member 65 slides against the inclined surface 63c of the cam sliding surface 63a of the first driven cam member 63, thereby generating axial cam thrust indicated by the arrow in FIG. 7C in the first driven cam member 63. This cam thrust causes the plurality of first pressing members 61 to press the engagement member 4 toward the engagement portion 324 of the output rotating member 32, whereby the engagement member 4 engages with the engagement portion 324. Meanwhile, the second thrust generation mechanism 6B remains in the inactive state, with the cam ball 661 staying in the deep groove portions 652c, 64c of the cam grooves 652b, 64b.

FIG. 7D illustrates a state in which the rotary cam member 65 has moved further to the right in the drawing from the state shown in FIG. 7C, and the base surface 651d of the cam sliding surface 651a of the rotary cam member 65 is in contact with the base surface 63d of the cam sliding surface 63a of the first driven cam member 63. In this state, no cam thrust is generated in the first driven cam member 63, However, movement of the engagement member 4 in a direction away from the engagement portion 324 of the output rotating member 32 is restricted, and the dog teeth 41 of the engagement member 4 remain engaged with the engagement teeth 324a of the engagement portion 324. The second thrust generation mechanism 6B remains in the inactive state.

When the normal mode is selected via the mode select switch 9, the control device 8 controls the electric motor 71 such that the rotary cam member 65 is moved to the position shown in FIG. 7A with respect to the first driven cam member 63 and the second driven cam member 64, thereby keeping both the first thrust generation mechanism 6A and the second thrust generation mechanism 6B in the inactive state. When the auto mode is selected via the mode select switch 9, the control device 8 activates the second thrust generation mechanism 6B in accordance with the traveling state of the vehicle to generate a frictional force in the friction clutch 5.

When the lock mode is selected via the mode select switch 9, the control device 8 controls the electric motor 71 to activate the first thrust generation mechanism 6A, thereby engaging the engagement member 4 with the engagement portion 324 of the output rotating member 32. Both the base surface 651d of the cam sliding surface 651a of the first cam portion 651 and the base surface 63d of the cam sliding surface 63a of the first driven cam member 63 are flat surfaces perpendicular to the axial direction. Therefore, even when the dog teeth 41 of the engagement member 4 receive an axial engagement reaction force from the engagement teeth 324a of the engagement portion 324, this engagement reaction force does not act as torque that rotates the rotary cam member 65.

Accordingly, the current supply to the electric motor 71 can be cut off while the vehicle is traveling in the lock mode. Even when the current supply to the electric motor 71 is cut off, the base surface 651d of the cam sliding surface 651a of the rotary cam member 65 and the base surface 63d of the cam sliding surface 63a of the first driven cam member 63 remain in contact with each other due to the rotational resistance of the rotary cam member 65, the reduction gear 72, and the rotor 71b of the electric motor 71.

The control device 8 detects contact between the base surface 651d of the cam sliding surface 651a of the rotary cam member 65 and the base surface 63d of the cam sliding surface 63a of the first driven cam member 63, based on, for example, a detection value from the position detector 71c of the electric motor 71, and sets the current supplied to the electric motor 71 to zero. This can reduce the current consumption of the electric motor 71. When rotation of the rotor 71b relative to the stator 71a of the electric motor 71 is detected due to vibration etc. while the vehicle is traveling in the lock mode, current is temporarily supplied to the electric motor 71 to return the rotor 71b to its original position, and then the current supply to the electric motor 71 is cut off again.

### Effects of Embodiment

According to the embodiment described above, the engagement member 4 is disposed inward of the friction clutch 5. This arrangement can reduce the axial length of the differential device 1 and can thus reduce the device size, compared to a case where the engagement member 4 and the friction clutch 5 are disposed side by side in the axial direction. Moreover, the engagement portion 324 of the output rotating member 32 is disposed inward of the outer peripheral spline fitting portion 323, and the first thrust generation mechanism 6A is disposed inward of the second thrust generation mechanism 6B. These arrangements also can reduce the axial length of the differential device 1 and can thus reduce the device size. Furthermore, the current supply to the electric motor 71 can be cut off while the vehicle is traveling in the lock mode. This can reduce power consumption of the electric motor 71.

### Additional Notes

Although the present disclosure has been described above based on the embodiment, this embodiment is not intended to limit the scope of the disclosure as defined by the claims. Not all combinations of features described in the embodiment are necessarily essential to means for solving the problem in the disclosure. The present disclosure can be implemented with modifications made as appropriate by omitting, adding, or replacing some of the components without departing from the spirit and scope of the disclosure. For example, the following modifications are possible.

The above embodiment illustrates an example in which the output rotating member 32 integrally includes the gear teeth 321, the boss portion 322, the outer peripheral spline fitting portion 323, and the engagement portion 324. However, the present disclosure is not limited to this, For example, the output rotating member 32 may be configured by combining a first member that integrally includes the gear teeth 321 and the boss portion 322, and a second member that includes the outer peripheral spline fitting portion 323 and the engagement portion 324, in such a manner that the first and second members are not rotatable relative to each other.

The above embodiment illustrates an example in which the friction clutch 5 and the engagement member 4 are provided for the right output rotating member 32 out of the left and right output rotating members 31, 32. However, the present disclosure is not limited to this. The friction clutch 5 and the engagement member 4 may be provided for the left output rotating member 31 instead. In other words, it is sufficient that the friction clutch 5 and the engagement member 4 are provided for one of the left and right output rotating members 31, 32.

The above embodiment illustrates an example in which the plurality of first pressing members 61 is fixed to the engagement member 4 by press-fitting. However, the present disclosure is not limited to this. Like the second pressing member 62, a base in the form of a flat plate and a plurality of cylindrical protrusions extending in the axial direction may be combined to form a single first pressing member, and the engagement member 4 may be pressed by the single first pressing member.

The above embodiment illustrates an example in which the current supply to the electric motor 71 is cut off while the vehicle is traveling in the lock mode. However, the present disclosure is not limited to this. A small current, sufficient to suppress rotation of the rotor 71b relative to the stator 71a of the electric motor 71, may be continuously supplied to the electric motor 71.

### REFERENCE SIGNS LIST

1 DIFFERENTIAL DEVICE
2 INPUT ROTATING MEMBER
31, 32 OUTPUT ROTATING MEMBER
323 OUTER PERIPHERAL SPLINE FITTING PORTION
323A EXTERNAL SPLINE
324 ENGAGEMENT PORTION
324a ENGAGEMENT TOOTH
33, 34 DIFFERENTIAL GEAR
4 ENGAGEMENT MEMBER
41 DOG TOOTH
5 FRICTION CLUTCH
51 OUTER CLUTCH PLATE
52 INNER CLUTCH PLATE
6A FIRST THRUST GENERATION MECHANISM
6B SECOND THRUST GENERATION MECHANISM
60 BEARING
61 FIRST PRESSING MEMBER
62 SECOND PRESSING MEMBER
63 FIRST DRIVEN CAM MEMBER
63a CAM SLIDING SURFACE
63b PERPENDICULAR SURFACE
63c INCLINED SURFACE
63d BASE SURFACE
64 SECOND DRIVEN CAM MEMBER
64b CAM GROOVE
64c DEEP GROOVE PORTION
64d INCLINED GROOVE PORTION
65 ROTARY CAM MEMBER
651a CAM SLIDING SURFACE
651b PERPENDICULAR SURFACE
651c INCLINED SURFACE
651d BASE SURFACE
652b CAM GROOVE
652c DEEP GROOVE PORTION
652d INCLINED GROOVE PORTION
661 CAM BALL
O ROTATION AXIS

1. A differential device comprising:
an input rotating member in a form of a case, the input rotating member being configured to receive driving force from a drive source and to rotate about a rotation axis by the driving force;
a pair of output rotating members housed in the input rotating member, the pair of output rotating members being configured to rotate about the rotation axis;
a plurality of differential gears housed in the input rotating member, the plurality of differential gears being configured to allow differential rotation between the pair of output rotating members;
an engagement member including dog teeth that are engageable with one of the pair of output rotating members, the engagement member being configured to axially move relative to the input rotating member to engage the dog teeth with the one output rotating member so as to make the one output rotating member non-rotatable relative to the input rotating member; and
a friction clutch disposed between the one output rotating member and the input rotating member, the friction clutch being configured to suppress differential rotation between the one output rotating member and the input rotating member by a frictional force, wherein
the engagement member and the friction clutch are arranged side by side in a radial direction perpendicular to the rotation axis and overlap each other in an axial direction, and the engagement member is disposed inward of the friction clutch in the radial direction.

2. The differential device according to claim 1, wherein:
the friction clutch includes a plurality of outer clutch plates that is axially movable and non-rotatable relative to the input rotating member, and a plurality of inner clutch plates that is axially movable and non-rotatable relative to the one output rotating member;
the one output rotating member includes an outer peripheral spline fitting portion including external splines with which the plurality of inner clutch plates engages, and an engagement portion including engagement teeth configured to engage with the dog teeth of the engagement member; and
the engagement portion is located inward of the outer peripheral spline fitting portion in the radial direction perpendicular to the rotation axis.

3. The differential device according to claim 2, further comprising:
a first pressing member configured to press the engagement member in an axial direction;
a second pressing member configured to press the friction clutch in the axial direction;
a first thrust generation mechanism configured to apply axial thrust to the first pressing member; and
a second thrust generation mechanism configured to apply axial thrust to the second pressing member, wherein the first thrust generation mechanism is provided at a location inward of the second thrust generation mechanism in the radial direction.

4. The differential device according to claim 3, wherein:
the first thrust generation mechanism is a sliding cam mechanism configured to apply the axial thrust to the first pressing member by relative rotation between a rotary cam member and a first driven cam member disposed so as to face the rotary cam member, the rotary cam member including a cam sliding surface that includes an inclined surface inclined with respect to the axial direction and a base surface perpendicular to the axial direction; and
when a portion of the first driven cam member slides on the inclined surface, the first pressing member presses the engagement member toward the engagement portion of the one output rotating member, and when a portion of the first driven cam member comes into contact with the base surface, a state in which the dog teeth of the engagement member are engaged with the engagement teeth of the engagement portion is maintained.

5. The differential device according to claim 4, wherein:
the second thrust generation mechanism is a ball cam mechanism configured to apply the axial thrust to the second pressing member by a rolling element in a form of a ball rolling on an inclined groove portion of a cam groove provided in the rotary cam member so as to be inclined with respect to the axial direction; and
the cam groove is located outward of the cam sliding surface in the radial direction perpendicular to the rotation axis.

6. The differential device according to claim 5, further comprising a bearing that rotatably supports the rotary cam member relative to the input rotating member, wherein movement of the rotary cam member in a direction away from the first driven cam member is restricted by the bearing.

7. The differential device according to claim 5, wherein:
the second thrust generation mechanism includes a second driven cam member disposed so as to face the rotary cam member; and
the first driven cam member is disposed inward of the second driven cam member in the radial direction perpendicular to the rotation axis.

8. The differential device according to claim 7, wherein the first driven cam member and the second driven cam member are engaged with each other so as to be axially movable relative to each other and non-rotatable relative to each other.
